(19) United States
(12) Patent Application Publication
(10) Pub. No.: US 2026/0266373 A1
(43) Pub. Date: Sep. 10, 2026

(54) SEALING OF AN END CAP OF AN AEROSOL-GENERATING DEVICE

(71) Applicant: Philip Morris Products S.A., Neuchatel (CH)

(72) Inventors: Teemu Henrik MÄÄTTÄNEN, Bern (CH); Yeong Taur EOW, Singapore (SG); Lilan XU, Singapore (SG)

(73) Assignee: Philip Morris Products S.A., Neuchatel (CH)

(21) Appl. No.: 19/131,071

(22) PCT Filed: Nov. 28, 2023
(86) PCT No.: PCT/EP2023/083276

§ 371 Date: May 19, 2025

(51) Int. Cl. F16J 15/02; A24F 40/40

(52) U.S. Cl. CPC F16J 15/025; A24F 40/40

(57) ABSTRACT

An end cap for an aerosol-generating device, including: an end cap body extending along an axial direction from a base section to a cap section; and a sealing with a sealing lip portion circumferentially surrounding and extending outwardly away from the base section, a resistance of the sealing lip portion to bend into the axial direction being smaller than a resistance of the sealing lip portion to bend against the axial direction, the sealing including a seating portion, the sealing lip portion extending outwardly from the seating portion, the base section including a circumferential groove, the seating portion being at least partially received in the groove, the groove including first and second groove portions, the second groove portion being downstream of the first groove portion with respect to the axial direction, and the second groove portion extending farther radially inward than the first groove portion.

The present disclosure relates to providing sealing for an aerosol-generating device.

Different types of aerosol-generating devices are known. For example, aerosol-generating devices according to a heat-not-burn type generally comprise a battery, control electronics, and an electric heater for heating an aerosol-generating article to generate aerosol for consumption by a user. In some examples, the aerosol-generating article comprises an aerosol-forming substrate, such as a tobacco segment or a tobacco plug, and the heater contained within the aerosol-generating device is inserted into or located around the aerosol-forming substrate, when the aerosol-generating article is inserted into the aerosol-generating device. According to another example, aerosol-generating devices according to a vaporizer type may be configured to heat aerosol-generating liquid from a cartridge to provide aerosol for consumption by a user. The cartridge may be configured as a refillable cartridge or as a disposable part.

There is a need to provide a way of preventing or reducing undesired entry of foreign matter, such as liquid or dust, into an aerosol-generating device.

According to a first aspect of the present invention, there is provided an end cap for an aerosol-generating device. The end cap comprises an end cap body and a sealing. The end cap body extends along an axial direction from a base section of the end cap body to a cap section of the end cap body. The sealing comprises a sealing lip portion. The sealing lip portion circumferentially surrounds the base section and extends outwardly away from the base section. A resistance of the sealing lip portion to bend into the axial direction is smaller than a resistance of the sealing lip portion to bend against the axial direction.

The end cap may be configured to form a part of an aerosol-generating device. The sealing lip portion may be configured to bend into the axial direction upon assembly of the aerosol-generating device. The sealing may be configured to seal a gap between the end cap body and one or more other parts of the aerosol-generating device. The sealing may prevent or reduce entry of foreign matter, such as liquid or dust, between the end cap body and one or more other parts of the aerosol-generating device. Bending of the sealing lip portion into the axial direction may facilitate establishing a sealing contact between the sealing lip portion and one or more other parts of the aerosol-generating device. The one or more other parts of the aerosol-generating device may comprise a housing sleeve of the aerosol-generating device.

The sealing lip portion may have a preferential bending direction, in particular since a resistance of the sealing lip portion to bend into the axial direction is smaller than the resistance of the sealing lip portion to bend against the axial direction. The preferential bending direction may be into the axial direction. The preferential bending direction of the sealing lip portion may help ensuring that sealing is properly established in the aerosol-generating device.

In view of the greater resistance of the sealing lip portion to bend against the axial direction, undesired bending of the sealing lip portion against the axial direction may be reduced, in particular during assembly of the aerosol-generating device or after assembly of the aerosol-generating device.

The cap section of the end cap body may be downstream of the base section of the end cap body along the axial direction.

The cap section may be configured to form at least a part of an outer surface of the aerosol-generating device. The cap section may comprise a surface with a main extension plane at least generally perpendicular to the axial direction. The cap section may be configured to at least partially form an end surface of the aerosol-generating device.

The base section may be configured to be provided within the aerosol-generating device. The base section may be configured to be received in the aerosol-generating device to be invisible from outside the aerosol-generating device.

The sealing may comprise an elastomeric material. The sealing may be formed of an elastomeric material. The sealing may consist of an elastomeric material. The elastomeric material may be a thermoplastic elastomer (TPE). The elastomeric material may be a rubber material. The elastomeric material may be a thermoplastic polyurethane (TPU). The elastomeric material may have a Shore A hardness between 60 and 80, in particular between 65 and 75, according to standard ASTM D2240.

The sealing may be provided as a one-piece structure.

A material composition of the sealing may be the same throughout the entirety of the sealing. Alternatively, different portions of the sealing may have different material compositions.

A preferential bending direction of the sealing lip portion may be caused by the shape of the sealing. Alternatively or additionally, a preferential bending direction of the sealing lip portion may be caused by material properties of the sealing lip portion.

The sealing may circumferentially surround the base section of the end cap body. The sealing may be in contact with an outer surface of the base section. The sealing may be in contact with the base section along a full circumference of the base section.

The sealing may be asymmetrical with respect to each plane perpendicular to the axial direction. The asymmetry may be so as to favor bending of the sealing lip portion into the axial direction over bending the sealing lip portion against the axial direction.

The sealing may be fixed to the end cap body. The sealing may be overmolded on the end cap body. A fixed connection between the sealing and the end cap body may reduce the risk of displacement of the sealing, in particular during assembly of the aerosol-generating device. A fixed connection between the sealing and the end cap body may ensure that correct positioning of the sealing with respect to the end cap body is maintained.

The sealing lip portion may comprise a first surface facing into the axial direction and a second surface facing against the axial direction. The first surface may be visible, when viewing the end cap in a viewing direction against the axial direction, but not visible when viewing the end cap in a viewing direction along the axial direction. The second surface may be visible when viewing the end cap in a viewing direction along the axial direction, but not when viewing the end cap in a viewing direction against the axial direction.

When the sealing lip portion is bent into the axial direction, the first surface may come to lie radially inside of the second surface. When the sealing lip portion is bent into the axial direction, the first surface may come to face the base section of the end cap body, with or without contact with the end cap body. When the sealing lip portion is bent into the axial direction, the second surface may come to face away from the base section of the end cap body. In the assembled aerosol-generating device, the second surface may be in contact with one or more parts of the aerosol-generating device laying radially outward of the base section of the end cap body, in particular with a housing sleeve of the aerosol-generating device.

The first surface and the second surface may taper towards each other along a direction radially outwards. A distance between the first surface and the second surface along the axial direction may decrease in a direction radially outwards. A thickness of the sealing lip portion in the axial direction may decrease in a direction radially outwards.

An end surface of the sealing lip portion may connect the first surface and the second surface with each other. The end surface may circumferentially extend around the end cap body.

The first surface may be a flat surface. The second surface may be a flat surface. The first surface and the second surface may be flat surfaces.

A first angle between the first surface and a plane perpendicular to the axial direction may be smaller than a second angle between the second surface and a plane perpendicular to the axial direction. Different inclinations of the first surface and the second surface may contribute to the preferential bending direction of the sealing lip portion. A small first angle may facilitate bending the sealing lip portion into the axial direction. A large second angle may increase a resistance against the sealing lip bending against the axial direction. The first angle may be between 1 degree and 40 degrees, or between 1 degree and 30 degrees, or between 1 degree and 20 degrees, or between 3 degrees and 15 degrees, or between 5 degrees and 10 degrees, for example. The second angle may be between 5 degrees and 80 degrees, or between 10 degrees and 70 degrees, or between 15 degrees and 60 degrees, or between 25 degrees and 45 degrees, or between 30 degrees and 40 degrees, for example.

The sealing may comprise a circumferential notch or groove. The circumferential notch or groove may be provided downstream of the sealing lip portion with respect to the axial direction. The circumferential notch or groove may extend around a full circumference of the base section of the end cap body. The circumferential notch or groove may provide a weakened portion in the sealing to facilitate bending the sealing lip portion into the axial direction. The circumferential notch or groove may provide a space that may be at least partially occupied by the sealing lip portion, when the sealing lip portion is bent into the axial direction.

The sealing may comprise a seating portion. The sealing lip portion may extend outwardly from the seating portion. The seating portion may be in contact with the base section of the end cap body. The seating portion may be in contact with the base section of the end cap body along a full circumference of the base section of the end cap body.

The base section may comprise a circumferential groove. The circumferential groove may extend around a full circumference of the base section. The seating portion may be at least partially received in the circumferential groove. The seating portion may be at least partially received in the circumferential groove around a full circumference of the base section. The seating portion may be stabilized by being at least partially received in the circumferential groove.

The seating portion may fully fill the circumferential groove. The seating portion may at least partly fill the circumferential groove.

The sealing lip portion may be provided at least partially radially outwards of the circumferential groove. The sealing lip portion may be accessible radially outwards of the circumferential groove. The sealing lip portion may extend at least partially radially outwards of the circumferential groove to be accessible for being bent in the axial direction.

The circumferential groove may comprise a first groove portion. The circumferential groove may comprise a second groove portion. The second groove portion may be provided downstream of the first groove portion with respect to the axial direction. The second groove portion may extend farther radially inward than the first groove portion. The second groove portion may be deeper than the first groove portion. The sealing, in particular the seating portion of the sealing, may be provided in both the first groove portion and the second groove portion. The second groove portion may provide space for the sealing to deform, when the sealing lip portion is bent into the axial direction. A reduced depth of the first groove portion may contribute to resisting bending of the sealing lip portion against the axial direction.

The base section of the end cap may be configured to be received in a housing sleeve of an aerosol-generating device so that the housing sleeve circumferentially surrounds the base section. The end cap and the housing sleeve may be combined by carrying out a sliding motion relative to each other in parallel to the axial direction. The base section of the end cap body may be configured to be fully received in the housing sleeve. The cap section of the end cap body may be configured to be provided outside the housing sleeve, when the base section is fully received in the housing sleeve. The cap section may be configured to at least partially close an opening of the housing sleeve. The opening of the housing sleeve may face along the axial direction.

The sealing lip portion may be configured to be bent into the axial direction by the housing sleeve sliding onto the base section of the end cap body. The sealing lip portion may be configured to be engaged by the housing sleeve upon sliding the housing sleeve onto the base section. The sealing lip portion may be configured to engage an inner surface of the housing sleeve, when the base section of the end cap body is received in the housing sleeve. The sealing lip portion may be configured to press against an inner surface of the housing sleeve, when the base section of the end cap body is received in the housing sleeve. A resilient force may act towards returning the sealing lip portion from a configuration in which the sealing lip portion is bent in the axial direction towards an unbent configuration. The resilient force may be due to material properties of the sealing, or due to a shape of the sealing, or both. The resilient force may press the sealing lip portion against an inner surface of the housing sleeve, when the base section of the end cap body is received in the housing sleeve. In particular, the resilient force may press the second surface of the sealing lip portion against the inner surface of the housing sleeve, when the base section of the end cap body is received in the housing sleeve.

The cap section may be configured to form a part of an outer surface of the aerosol-generating device.

A cross-section of the sealing in a plane perpendicular to the circumferential direction may be the same fully around the circumferential direction. The sealing may provide a sealing function fully around the base section of the end cap body.

The end cap body may comprise a radially outwardly extending abutment surface. The abutment surface may be provided downstream of the sealing lip portion with respect to the axial direction. The abutment surface may face against the axial direction. The abutment surface may be perpendicular to the axial direction. The abutment surface may be configured as an end stop for the housing sleeve. The abutment surface may extend around a full circumference of the end cap body.

The abutment surface may extend radially outwards at least as far as the sealing lip portion. The abutment surface may extend radially outwards as far as the sealing lip portion. The abutment surface may extend radially outwards farther than the sealing lip portion.

When the sealing lip portion is bent into the axial direction, the sealing lip portion may be bent towards the abutment surface.

The end cap body may comprise outwardly extending centering parts at different circumferential positions around the end cap body. The centering parts may be configured to engage the housing sleeve, when the housing sleeve is slid onto the base section. The centering parts may be provided at the base section. The centering parts may be integrally formed with the base section. The centering parts may be configured to center the housing sleeve so that the housing sleeve is provided in a co-axial arrangement with the end cap body.

The centering parts may comprise between two and twelve centering parts, or between four and eight centering parts, or between five and seven centering parts, for example. The centering parts may comprise pairs of centering parts provided opposite with respect to each other.

The centering parts may be provided upstream of the sealing with respect to the axial direction. The centering parts may be configured to at least partially center the housing sleeve before the housing sleeve engages the sealing lip portion. The centering parts may center the housing sleeve so that the housing sleeve is at least generally co-axial with the sealing lip portion.

The sealing lip portion may extend farther radially outwards than the centering parts.

According to a second aspect of the present invention, there is provided a housing sleeve for an aerosol-generating device. The housing sleeve comprises a sleeve body. The sleeve body extends from a first end of the sleeve body along an axial direction to a second end of the sleeve body. The sleeve body comprises a sleeve wall circumferentially extending around the axial direction, thereby surrounding an inner space. The sleeve wall defines an opening into the inner space at the second end of the sleeve body. The sleeve wall comprises a circumferential chamfer connecting an inner surface of the sleeve wall facing towards the inner space and an end surface of the sleeve wall facing into the axial direction.

The chamfer may provide a guiding function for assembling an end cap in the opening of the sleeve. The chamfer may be helpful in deforming a sealing arranged at the end cap upon assembling the housing portion with the end cap. The chamfer may reduce the likelihood of damaging a sealing, when the sleeve body contacts the sealing.

The inner surface of the sleeve wall may extend fully around a circumferential direction. The inner surface of the sleeve wall may at least partially delimit the inner space.

The opening may face into the axial direction. The end surface of the sleeve wall may be provided at the second end of the sleeve body.

The chamfer may be inclined with respect to a plane perpendicular to the axial direction by between 15 degrees and 75 degrees, or between 30 degrees and 60 degrees, or between 40 degrees and 50 degrees.

The chamfer may extend fully around the axial direction.

The end cap according to the first aspect and the housing sleeve according to the second aspect may be interrelated products. The end cap according to the first aspect and the housing sleeve according to the second aspect may be configured to be combined to form at least a part of a housing of an aerosol-generating device. The end cap according to the first aspect and the housing sleeve according to the second aspect may be combined by a sliding motion relative to each other in parallel to the axial direction, such that the housing sleeve slides over the base section of the end cap body to circumferentially surround the base section of the end cap body.

According to a third aspect of the present invention, there is provided an aerosol-generating device. The aerosol-generating device comprises the end cap according to the first aspect, and a housing sleeve. The housing sleeve may comprise a sleeve body extending from a first end of the sleeve body along the axial direction to a second end of the sleeve body. The sleeve body may comprise a sleeve wall circumferentially extending around the axial direction, thereby surrounding an inner space. The sleeve wall may define an opening into the inner space at the second end of the sleeve body. The housing sleeve and the end cap may be configured to be combined by sliding the housing sleeve relative to the end cap along the axial direction so that the base section of the end cap body is received in the inner space of the housing sleeve.

The sealing lip portion may be configured to bend into the axial direction upon combining the housing sleeve and the end cap.

The sealing lip portion may be configured to press against an inner surface of the sleeve wall, when the housing sleeve and the end cap are combined.

The housing sleeve may be the housing sleeve according to the second aspect.

The chamfer may be configured to engage the sealing lip portion upon combining the housing sleeve and the end cap.

According to a fourth aspect of the present invention, there is provided a method for combining a housing sleeve and an end cap to form at least a part of a housing for an aerosol-generating device. The method comprises sliding the housing sleeve relative to the end cap along an axial direction so that a base section of an end cap body of the end cap is received in an inner space of the housing sleeve. Upon the sliding, a sealing lip portion of a sealing circumferentially surrounding the base section is deformed to bend into the axial direction by engagement with a chamfer of the housing sleeve.

After combining the housing sleeve and the end cap, the sealing lip portion may press against an inner wall of the housing sleeve.

A resistance of the sealing lip portion against combining the housing sleeve and the end cap by sliding the housing sleeve relative to the end cap along an axial direction may be smaller than a resistance of the sealing lip portion against disassembling the housing sleeve from the end cap by sliding the housing sleeve relative to the end cap against the axial direction.

The end cap may be the end cap according to the first aspect.

The housing sleeve may be the housing sleeve according to the second aspect.

According to a fifth aspect of the present invention, a use of a chamfer of a housing sleeve is provided. The chamfer of the housing sleeve is used to facilitate bending a sealing lip portion of a sealing provided at an end cap body upon sliding the housing sleeve onto the end cap body with a relative motion between the end cap body and the housing sleeve.

The housing sleeve and the end cap body may together form at least a part of a housing of an aerosol-generating device.

The end cap body may be the end cap body of the end cap according to the first aspect. The sealing may be the sealing of the end cap according to the first aspect.

The housing sleeve may be the housing sleeve according to the second aspect.

The statement used herein that a resistance of the sealing lip portion to bend into the axial direction is smaller than a resistance of the sealing lip portion to bend against the axial direction applies at least for the end cap, when provided as a separate item without interaction with other items, such as the housing sleeve, for example. Optionally, the statement may also apply in con-figurations of the end cap that the end cap assumes, when interacting with other components.

The present disclosure comprises various aspects, embodiments, and examples. Features, advantages, and explanations disclosed with reference to any one of these aspects, embodiments, and examples may be combined with, or transferred to, any other one of the aspects, embodiments, and examples described herein.

The invention is defined in the claims. However, below there is provided a non-exhaustive list of non-limiting examples. Any one or more of the features of these examples may be combined with any one or more features of another example, embodiment, or aspect described herein.

Example Ex1: An end cap for an aerosol-generating device, the end cap comprising:
an end cap body extending along an axial direction from a base section of the end cap body to a cap section of the end cap body; and
a sealing with a sealing lip portion circumferentially surrounding the base section and extending outwardly away from the base section;
wherein a resistance of the sealing lip portion to bend into the axial direction is smaller than a resistance of the sealing lip portion to bend against the axial direction.

Example Ex2: End cap according to Example Ex1, wherein the sealing is asymmetrical with respect to each plane perpendicular to the axial direction.

Example Ex3: End cap according to Example Ex1 or Ex2, wherein the sealing is over-molded on the end cap body.

Example Ex4: End cap according to any one of Examples Ex1 to Ex3, wherein the sealing lip portion comprises a first surface facing into the axial direction and a second surface facing against the axial direction.

Example Ex5: End cap according to Example Ex4, wherein the first surface and the second surface taper towards each other along a direction radially outwards.

Example Ex6: End cap according to Example Ex4 or Ex5, wherein one or both of the first surface and the second surface is a flat surface.

Example Ex7: End cap according to any one of Examples Ex4 to Ex6, wherein a first angle between the first surface and a plane perpendicular to the axial direction is smaller than a second angle between the second surface and a plane perpendicular to the axial direction.

Example Ex8: End cap according to any one of Examples Ex1 to Ex7, wherein the sealing comprises a circumferential notch preferably provided downstream of the sealing lip portion with respect to the axial direction.

Example Ex9: End cap according to any one of Examples Ex1 to Ex8, wherein the sealing comprises a seating portion, wherein the sealing lip portion extends outwardly from the seating portion.

Example Ex10: End cap according to Example Ex9, wherein the base section comprises a circumferential groove; and
wherein the seating portion is at least partially received in the circumferential groove.

Example Ex11: End cap according to Example Ex10, wherein the sealing lip portion is least partially provided radially outwards of the circumferential groove.

Example Ex12: End cap according to Example Ex10 or Ex11, wherein the circumferential groove comprises a first groove portion and a second groove portion downstream of the first groove portion with respect to the axial direction, and wherein the second groove portion extends farther radially inward than the first groove portion.

Example Ex13: End cap according to any one of Examples Ex1 to Ex12, wherein the base section is configured to be received in a housing sleeve of an aerosol-generating device so that the housing sleeve circumferentially surrounds the base section.

Example Ex14: End cap according to Example Ex13, wherein the sealing lip portion is configured to be bent into the axial direction by the housing sleeve sliding onto the base section.

Example Ex15: End cap according to any one of Examples Ex1 to Ex14, wherein the cap section is configured to form a part of an outer surface of the aerosol-generating device.

Example Ex16: End cap according to any one of Examples Ex1 to Ex15, wherein a cross-section of the sealing in a plane perpendicular to the circumferential direction is the same fully around the circumferential direction.

Example Ex17: End cap according to any one of Examples Ex1 to Ex16, wherein the end cap body comprises a radially outwardly extending abutment surface downstream of the sealing lip portion of the sealing with respect to the axial direction.

Example Ex18: End cap according to Example Ex17, wherein the abutment surface extends radially outwards at least as far as the sealing lip portion of the seal.

Example Ex19: End cap according to any one of Examples Ex1 to Ex18, wherein the end cap body comprises outwardly extending centering parts at different circumferential positions around the end cap body.

Example Ex20: End cap according to Example Ex19, wherein the centering parts are provided upstream of the sealing with respect to the axial direction.

Example Ex21: End cap according to Example Ex19 or Ex20, wherein the sealing lip portion of the sealing extends farther radially outwards than the centering parts.

Example Ex22: A housing sleeve for an aerosol-generating device, the housing sleeve comprising:
a sleeve body extending from a first end of the sleeve body along an axial direction to a second end of the sleeve body;
wherein the sleeve body comprises a sleeve wall circumferentially extending around the axial direction, thereby surrounding an inner space;
wherein the sleeve wall defines an opening into the inner space at the second end of the sleeve body; and
wherein the sleeve wall comprises a circumferential chamfer connecting an inner surface of the sleeve wall facing towards the inner space and an end surface of the sleeve wall facing into the axial direction.

Example Ex23: Housing according to Example Ex22, wherein the chamfer is inclined with respect to a plane perpendicular to the axial direction by between 15 degrees and 75 degrees, or between 30 degrees and 60 degrees, or between 40 degrees and 50 degrees.

Example Ex24: Aerosol-generating device, comprising:
the end cap according to any one of Examples Ex1 to Ex21; and
a housing sleeve comprising a sleeve body extending from a first end of the sleeve body along the axial direction to a second end of the sleeve body;
wherein the sleeve body comprises a sleeve wall circumferentially extending around the axial direction, thereby surrounding an inner space;
wherein the sleeve wall defines an opening into the inner space at the second end of the sleeve body; and
wherein the housing sleeve and the end cap are configured to be combined by sliding the housing sleeve relative to the end cap along the axial direction so that the base section of the end cap body is received in the inner space of the housing sleeve

Example Ex25: Aerosol-generating device according to Example Ex24, wherein the sealing lip portion is configured to bend into the axial direction upon combining the housing sleeve and the end cap.

Example Ex26: Aerosol-generating device according to Example Ex24 or Ex25, wherein the sealing lip portion is configured to press against an inner surface of the sleeve wall, when the housing sleeve and the end cap are combined.

Example Ex27: Aerosol-generating device according to any one of Examples Ex24 to Ex 26, wherein the housing sleeve is the housing sleeve according to Example Ex 22 or Ex 23.

Example Ex28: Aerosol-generating device according to Example Ex27, wherein the chamfer is configured to engage the sealing lip portion upon combining the housing sleeve and the end cap.

Example Ex29: Method for combining a housing sleeve and an end cap to form at least a part of a housing for an aerosol-generating device, the method comprising:
sliding the housing sleeve relative to the end cap along an axial direction so that a base section of an end cap body of the end cap is received in an inner space of the housing sleeve;
wherein upon the sliding, a sealing lip portion of a sealing circumferentially surrounding the base section is deformed to bend into the axial direction by engagement with a chamfer of the housing sleeve.

Example Ex30: Method according to Example Ex29, wherein after combining the housing sleeve and the end cap, the sealing lip portion presses against an inner wall of the housing sleeve.

Example Ex31: Method according to Example Ex29 or Ex30, wherein a resistance of the sealing lip portion against combining the housing sleeve and the end cap by the sliding the housing sleeve relative to the end cap along an axial direction is smaller than a resistance of the sealing lip portion against disassembling the housing sleeve from the end cap by sliding the housing sleeve relative to the end cap against the axial direction.

Example Ex32: Method according to any one of Examples Ex29 to Ex31, wherein the end cap is the end cap according to any one of Examples Ex1 to Ex21.

Example Ex33: Method according to any one of Examples Ex29 to Ex32, wherein the housing sleeve is the housing sleeve according to Example Ex22 or Ex23.

Example Ex34: Use of a chamfer of a housing sleeve to facilitate bending a sealing lip portion of a sealing provided at an end cap body upon sliding the housing sleeve onto the end cap body with a relative motion between the end cap body and the housing sleeve.

Example Ex35: Use according to Example Ex34, wherein the end cap body is the end cap body of the end cap according to any one of Examples Ex1 to Ex21.

Example Ex36: Use according to Example Ex34 or Ex35, wherein the housing sleeve is the housing sleeve according to Example Ex22 or Ex23.

Examples will now be further described with reference to the Figures in which:

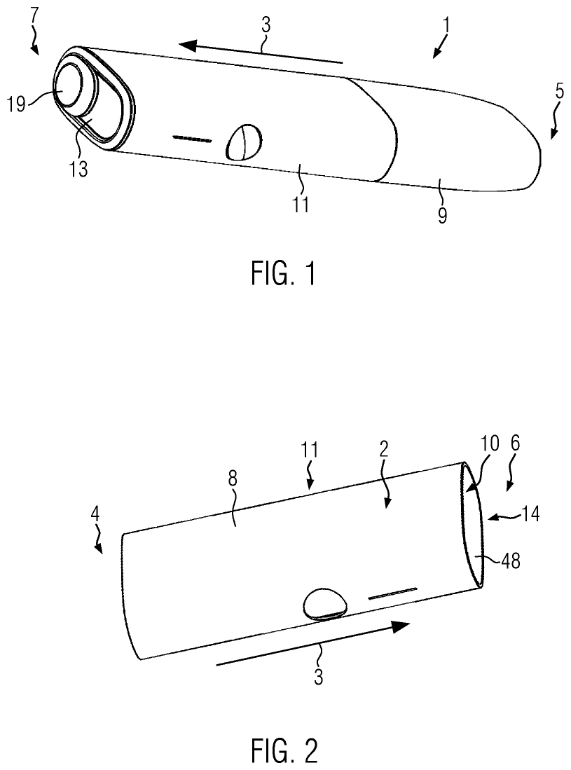

FIG. 1 shows a schematic perspective view of an aerosol-generating device according to an embodiment;

FIG. 2 shows a schematic perspective view of a housing sleeve of the aerosol-generating device according to the embodiment;

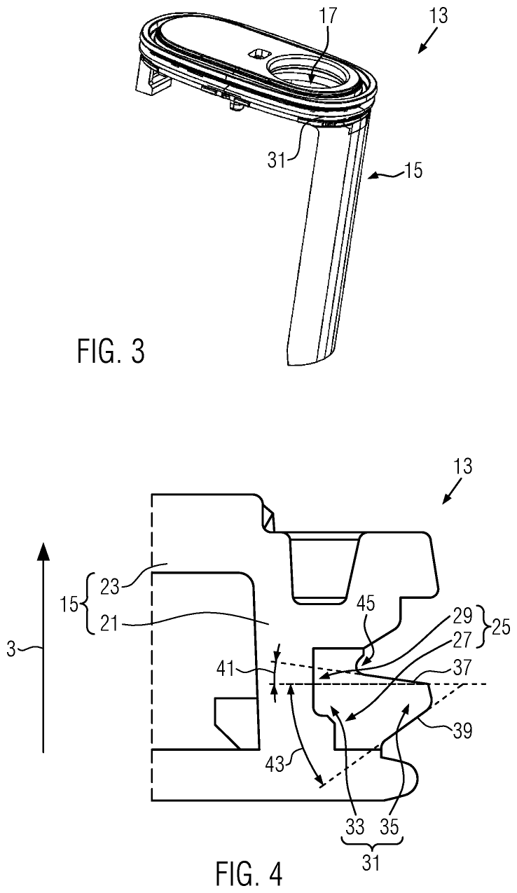

FIG. 3 shows a schematic perspective view of an end cap of the aerosol-generating device according to the embodiment;

FIG. 4 shows a schematic sectional view of the end cap with the sectional plane being parallel to the axial direction;

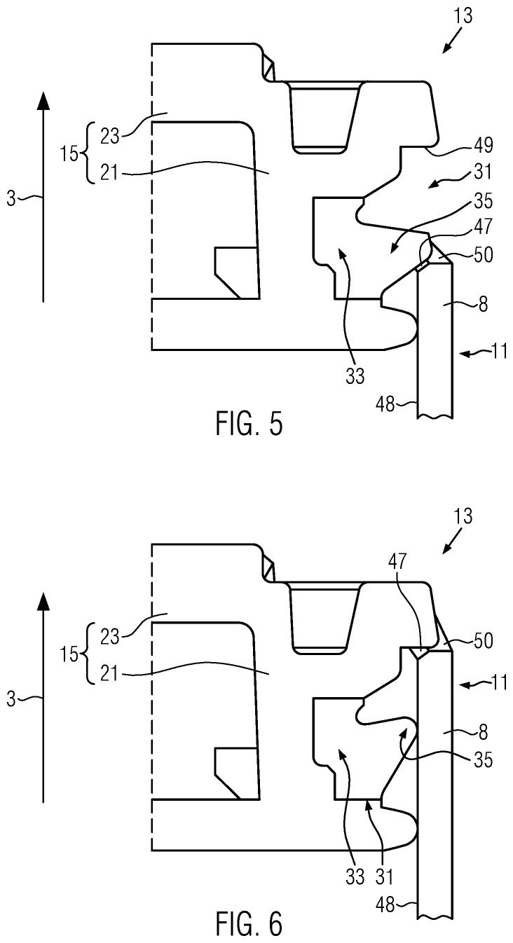

FIG. 5 shows an intermediate state during assembly of the end cap with the housing sleeve in a schematic sectional view with the sectional plane being parallel to the axial direction;

FIG. 6 shows a final state during assembly of the end cap with the housing sleeve in the schematic sectional view with the sectional plane being parallel to the axial direction;

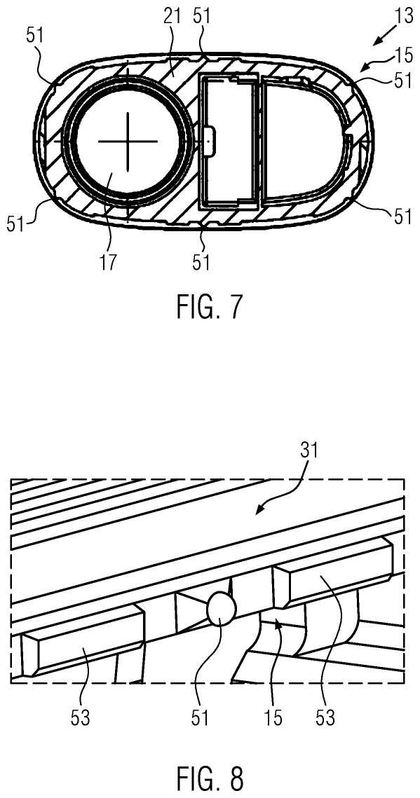

FIG. 7 shows a schematic view onto the end cap with a viewing direction along the axial direction; and

FIG. 8 shows a schematic perspective view of centering features provided at the end cap according to the embodiment.

FIG. 1 shows an aerosol-generating device 1 according to an embodiment. The aerosol-generating device 1 is a handheld device extending along an axial direction 3 between a distal end 5 and a proximal end 7. The aerosol-generating device 1 has a generally rod-shaped configuration. The aerosol-generating device 1 comprises a housing having a first housing sleeve 9, a second housing sleeve 11, and an end cap 13. The first housing sleeve 9 and the second housing sleeve 11 are arranged one behind the other along the axial direction 3. Alternatively, the first housing sleeve 9 and the second housing sleeve 11 may be formed as one part. The first housing sleeve 9 and the second housing sleeve 11 at least partially define an outer appearance of the aerosol-generating device 1. The first housing sleeve 9 and the second housing sleeve 11 cover internal components of the aerosol-generating device 1.

At the proximal end 7 of the aerosol-generating device 1, the second housing sleeve 11 comprises an opening 14. The second housing sleeve 11 with the opening 14 is separately shown in FIG. 2. The second housing sleeve 11 comprises a sleeve body 2 extending along the axial direction 3 from a first end 4 of the sleeve body 2 to a second end 6 of the sleeve body 2. The sleeve body 2 comprises a sleeve wall 8 circumferentially enclosing an inner space 10. The opening 14 of the second housing sleeve 11 opens into the inner space 10 at the second end 6 of the sleeve body 2.

The end cap 13 is at least partially provided in the opening 14 of the second housing sleeve 11. The end cap 13 at least partially closes the opening 14 of the second housing sleeve 11.

The end cap 13 is separately shown in FIG. 3. The end cap 13 comprises an end cap body 15 with an opening 17 facing into the axial direction 3. The end cap 13 further comprises a sliding cover 19. The sliding cover 19 is shown in FIG. 1 and omitted in FIG. 3. The sliding cover 19 may be slid in perpendicular to the axial direction 3 between a closed position shown in FIG. 1 and an open position. In the closed position, the sliding cover 19 covers the opening 17 of the end cap body 15. In the open position, the sliding cover 19 does not cover the opening 17 of the end cap body 15, so that the opening 17 is accessible.

An aerosol-generating article may be at least partially inserted into the aerosol-generating device 1 through the opening 17 of the end cap body 15. A heating device is provided within the aerosol-generating device 1, in particular in the inner space 10, to heat the aerosol-generating article so as to release aerosol for consumption by a user. The aerosol-generating article may be a rod-shaped article comprising multiple sections arranged one behind the other along an extension direction of the article. The aerosol-generating article may comprise an aerosol-generating section comprising material that is configured to release aerosol upon being heated. The material may, for example, comprise herbaceous material, in particular tobacco material. The aerosol-generating article may further comprise a filter section comprising a filter. The filter may at least partially protrude from the aerosol-generating device 1, when the aerosol-generating article is inserted in the aerosol-generating device 1. The filter may be engaged by mouth of a user to draw aerosol. The aerosol-generating article may further comprise a spacer section provided between the aerosol-generating section and the filter section. The spacer section may allow aerosol passing through the spacer section to cool before reaching the filter section. The sections of the aerosol-generating article may be combined by wrapping with a wrapper such as a paper wrapper.

FIG. 4 is a sectional view of the end cap 13 in a sectional plane parallel to the axial direction 3. The end cap body 15 comprises a base section 21 and a cap section 23. The cap section 23 is provided downstream of the base section 21 with respect to the axial direction 3.

In the assembled aerosol-generating device 1, the base section 21 is received in the inner space 10 of the second housing sleeve 11. The cap section 23 extends outside the second housing sleeve 11 in the assembled aerosol-generating device 1. The cap section 23 at least partially covers the opening 14 of the second housing sleeve 11. The opening 17 of the end cap body 15 is provided in the cap section 23.

The base section 21 of the end cap body 15 comprises a circumferential groove 25. The circumferential groove 25 extends circumferentially fully around the base section 21. The circumferential groove 25 comprises a first groove portion 27 and a second groove portion 29. The second groove portion 29 is provided downstream of the first groove portion 27 with respect to the axial direction 3. The second groove portion 29 extends farther radially inward than the first groove portion 27. The second groove portion 29 may be deeper than the first groove portion 27.

The end cap 13 comprises a sealing 31. The sealing 31 extends around a full circumference of the base section 21 of the end cap body 15. The sealing 31 comprises a seating portion 33 received in the circumferential groove 25 and a sealing lip portion 35 outwardly extending from the seating portion 33. The sealing lip portion 35 comprises a first surface 37 facing in the axial direction 3 and a second surface 39 facing against the axial direction 3. The first surface 37 and the second surface 39 are flat surfaces tapering towards each other along a direction radially outwards. A first angle 41 between the first surface 37 and a plane perpendicular to the axial direction 3 is smaller than a second angle 43 between the second surface 39 and the plane perpendicular to the axial direction 3.

The sealing 31 comprises a circumferential notch 45 downstream of the sealing lip portion 35 with respect to the axial direction 3.

Due to the geometry of the sealing 31 and the circumferential groove 25, the sealing lip portion 35 is easier to bend into the axial direction 3 than against the axial direction 3. A resistance of the sealing lip portion 35 to bend into the axial direction 3 is smaller than a resistance of the sealing lip portion 35 to bend against the axial direction 3. In FIG. 4, bending into the axial direction 3 means that the tip of the sealing lip portion 35 moves upwards. In FIG. 4, bending against the axial direction 3 means that the tip of the sealing lip portion 35 moves downwards.

To assemble the end cap 13 with the second housing sleeve 11, the second housing sleeve 11 is slid onto the base section 21 of the end cap body 15 in a relative motion between the second housing sleeve 11 and the end cap 13. FIG. 5 shows an intermediate state during the sliding. The sleeve wall 8 comprises a circumferential chamfer 47 connecting an inner surface 48 of the sleeve wall 8 facing towards the inner space 10 and an end surface 50 of the sleeve wall 10 facing into the axial direction 3. In the intermediate state shown in FIG. 5, the chamfer 47 of the second housing sleeve 11 has just engaged the sealing lip portion 35. When the second housing sleeve 11 is further slid along the axial direction 3 relative to the end cap 13, the sealing lip portion 35 bends upwards in the axial direction 3 due to engagement with the sleeve wall 8. At the end of the sliding motion, the sleeve wall 8 engages an abutment surface 49 of the end cap body 15. The abutment surface 49 functions as an end stop for the sleeve body 2.

FIG. 6 shows the mutual relation between the end cap 13 and the second housing sleeve 11 in the fully assembled state. The sealing lip portion 35 has been bent into the axial direction 3 and engages the inner surface 48 of the sleeve wall 8. The sealing 31 seals a gap between the end cap body 15 and the sleeve wall 8 to protect components provided within the aerosol-generating device 1.

FIG. 7 shows a view of the end cap 13 in a viewing direction along the axial direction 3. Centering parts 51 are provided at various positions at the base section 21 of the end cap body 15. The centering parts 51 outwardly protrude from the end cap body 15. In the illustrated embodiment, six centering parts 51 are provided at different positions along the circumference of the end cap body 15. The centering parts 51 may be integral with the end cap body 15.

FIG. 8 shows an enlarged view of a centering part 51. In the illustrated embodiment, the centering parts 51 comprise essentially spherical surfaces for engaging the inner surface 48 of the sleeve wall 8 to center the second housing sleeve 11 with respect to the end cap 13 upon assembly of the second housing sleeve 11 with the end cap 13. In the illustrated embodiment, guiding surfaces 53 are provided to both lateral sides of each centering part 51 to provide further guidance for the second housing sleeve 11.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±{10 percent} of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention Also, all ranges include the maximum and minimum points disclosed and include any intermediate ranges therein, which may or may not be specifically enumerated herein.

1.-15. (canceled)

16. An end cap for an aerosol-generating device, the end cap comprising:
an end cap body extending along an axial direction from a base section of the end cap body to a cap section of the end cap body; and
a sealing with a sealing lip portion circumferentially surrounding the base section and extending outwardly away from the base section,
wherein a resistance of the sealing lip portion to bend into the axial direction is smaller than a resistance of the sealing lip portion to bend against the axial direction,
wherein the sealing comprises a seating portion, wherein the sealing lip portion extends outwardly from the seating portion,
wherein the base section comprises a circumferential groove,
wherein the seating portion is at least partially received in the circumferential groove,
wherein the circumferential groove comprises a first groove portion and a second groove portion downstream of the first groove portion with respect to the axial direction, and
wherein the second groove portion extends farther radially inward than the first groove portion.

17. The end cap according to claim 16, wherein the sealing is asymmetrical with respect to each plane perpendicular to the axial direction.

18. The end cap according to claim 16,
wherein the sealing lip portion comprises a first surface facing into the axial direction and a second surface facing against the axial direction, and
wherein a first angle between the first surface and a plane perpendicular to the axial direction is smaller than a second angle between the second surface and a plane perpendicular to the axial direction.

19. The end cap according to claim 16, wherein the sealing further comprises a circumferential notch with respect to the axial direction.

20. The end cap according to claim 19, wherein the circumferential notch is provided downstream of the sealing lip portion.

21. The end cap according to claim 16, wherein the end cap body comprises a radially outwardly extending abutment surface downstream of the sealing lip portion of the sealing with respect to the axial direction.

22. The end cap according to claim 16, wherein the end cap body comprises outwardly extending centering parts at different circumferential positions around the end cap body.

23. The end cap according to claim 16, wherein the cap section is configured to form at least a part of an outer surface of the aerosol-generating device.

24. A housing sleeve for an aerosol-generating device, the housing sleeve comprising:
a sleeve body extending from a first end of the sleeve body along an axial direction to a second end of the sleeve body,
wherein the sleeve body comprises a sleeve wall circumferentially extending around the axial direction, thereby surrounding an inner space,
wherein the sleeve wall defines an opening into the inner space at the second end of the sleeve body, and
wherein the sleeve wall comprises a circumferential chamfer connecting an inner surface of the sleeve wall facing towards the inner space and an end surface of the sleeve wall facing into the axial direction.

25. Aerosol-generating device, comprising:
the end cap according to claim 16; and
a housing sleeve comprising a sleeve body extending from a first end of the sleeve body along the axial direction to a second end of the sleeve body,
wherein the sleeve body comprises a sleeve wall circumferentially extending around the axial direction, thereby surrounding an inner space,
wherein the sleeve wall defines an opening into the inner space at the second end of the sleeve body, and
wherein the housing sleeve and the end cap are configured to be combined by sliding the housing sleeve relative to the end cap along the axial direction so that the base section of the end cap body is received in the inner space of the housing sleeve.

26. The aerosol-generating device according to claim 25, wherein the sealing lip portion of the end cap is configured to bend into the axial direction upon combining the housing sleeve and the end cap.

27. A method for combining a housing sleeve and an end cap to form at least a part of a housing for an aerosol-generating device, the method comprising:
sliding the housing sleeve relative to the end cap along an axial direction so that a base section of an end cap body of the end cap is received in an inner space of the housing sleeve,
wherein upon the sliding, a sealing lip portion of a sealing circumferentially surrounding the base section is deformed to bend into the axial direction by engagement with a chamfer of the housing sleeve.

28. The method according to claim 27, wherein a resistance of the sealing lip portion against combining the housing sleeve and the end cap by the sliding the housing sleeve relative to the end cap along an axial direction is smaller than a resistance of the sealing lip portion against disassembling the housing sleeve from the end cap by sliding the housing sleeve relative to the end cap against the axial direction.

29. A chamfer of a housing sleeve, the chamfer being configured to facilitate bending a sealing lip portion of a sealing provided at an end cap body upon sliding the housing sleeve onto the end cap body with a relative motion between the end cap body and the housing sleeve.
